(19) United States
(12) Patent Application Publication
(10) Pub. No.: US 2026/0129466 A1
(43) Pub. Date: May 7, 2026

(54) CELL DEPLOYMENT OPTIMIZER

(71) Applicant: T-MOBILE INNOVATIONS LLC., Overland Park, KS (US)

(72) Inventor: Mohamed Mahrous SHALTOT, Chandler, AZ (US)

(21) Appl. No.: 18/939,239

(22) Filed: Nov. 6, 2024

(51) Int. Cl. H04W 16/18

(52) U.S. Cl. CPC H04W 16/18

(57) ABSTRACT

At a high level, the technology disclosed herein relates to methods, systems, media, etc., for cell deployment optimization (e.g., via a cell deployment optimization engine). In embodiments, cell deployment optimization relates to particular technological approaches to deploying a cell (e.g., such as a macro cell or a small cell) based on user experiences (e.g., user device network coverage experiences), home locations for user devices, historical locations for user devices, churn rates, predicted cell deployment coverage data, etc. For example, in embodiments, a user experience for subscribers located within a threshold distance of a proposed cell deployment location may be determined. In addition, one or more user experience adjustments to the user experience for the subscribers may be determined based on deploying a cell at the proposed cell deployment location. A cell deployment prediction may be generated based on the user experience adjustments.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for cell deployment optimization. For example, the technology disclosed herein relates to cell deployment predictions (e.g., deployment of a macro cell or a small cell) based on user experiences (e.g., user device network coverage experiences), home locations for user devices, historical locations for user devices, churn rates, predicted cell deployment coverage data, etc. In embodiments, user experiences may be determined (e.g., a network experience score corresponding to network quality from the user device's perspective, such as data transmission speed, latency, consistency and stability of the network connection, geographical coverage area, quality of service, network accessibility, etc.) by a cell deployment optimization engine. In some embodiments, the user experiences may be determined for subscribers having historical location data within a threshold distance of a proposed cell deployment location.

In embodiments, a user experience adjustment to the user experience for the subscribers may be determined based on deploying a cell at the proposed cell deployment location. For example, user experience adjustments may be made to a user experience based on predicted network coverage data upon the cell being deployed at the proposed cell deployment location (e.g., based on historical location data of the user device having the user experience, based on predicted transmit power for the cell being deployed, based on a predicted antenna gain for the cell being deployed, based on a predicted frequency band for the cell being deployed, based on a predicted deployment density for the cell being deployed, based on a predicted antenna configuration for the cell being deployed, based on predicted interference metrics for the cell being deployed, based on a height of the cell being deployed, etc.). One or more cell deployment predictions may be provided based on the user experience adjustment.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for utilizing a cell deployment optimization engine, in accordance with embodiments herein;

FIG. 2 depicts an example table including user experience adjustments determined by the cell deployment optimization engine, in accordance with embodiments herein;

FIG. 3 depicts an example graph including churn rates, in accordance with embodiments herein;

FIG. 4 depicts an example graphical display of nodes at different node locations, the nodes corresponding to coverage data (e.g., for computing devices that each have a churn probability and that each have signal experiences with currently deployed cells) for proposed cell deployment location(s), in accordance with embodiments herein;

FIG. 5 depicts an example cell deployment optimization engine output of a graphical display of nodes corresponding to predicted cell deployment coverage data for proposed cell deployment locations, in accordance with embodiments herein;

FIG. 6 depicts an example flowchart for cell deployment optimization, in accordance with embodiments herein; and

FIG. 7 depicts an example cell deployment optimization client and corresponding functionality associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, traditional deployment of cells (e.g., a macro cell) includes considerations including whether the new cell will interfere with an existing network infrastructure, integration techniques for backhaul establishment to integrate the new cell with a broader network, and identification of high user areas. Traditional radio wave propagation models (e.g., Okumura-Hata model, ray tracing models) used for analyzing wireless communication systems have some limitations, such as being less accurate for complex environments (e.g., dense urban areas with high-rise buildings) or remote environments, being limited to specified frequency and distance ranges, not having enough environmental data for precise results, and so forth. As the number of users with mobile devices (e.g., and the number of internet-accessible devices) continues to increase, the amount of traffic requesting support from cell sites will increase, which can cause high latency rates at cells and can decrease available bandwidth and throughput of traffic at the cells. Historically, cell deployment determinations have included application of an index at high level, where radio frequency metrics have been applied to a sector or cell site serving an area, and then enhancing the coverage in that particular sector.

It would be desirable for enhanced cell deployment systems to more accurately predict cell deployment metrics at a more granular level and without interfering with an existing network infrastructure, as well as enhanced cell deployment systems that have the capability to accurately predict cell deployment metrics for complex environments and remote locations, and thereby reducing latency rates, increasing available bandwidth, and increasing throughput of traffic at cells.

Embodiments of the technology discussed herein provide various improvements to cell deployment predictions. For example, the technology described herein can improve upon radio frequency coverage in enhanced ways to thereby improve network performance, improve upon user device experiences, reduce network congestion, reduce latencies and packet transmission delays, reduce performance degradations, increase available bandwidth, and increase throughput (e.g., by accurately predicting cell deployment metrics for a new cell that is to be deployed in a complex environment or remote environment). By way of example, by determining user experience adjustments (e.g., for subscribers) based on a future deployment of a cell at a proposed cell deployment location, a cell deployment optimization engine can provide cell deployment predictions that more accurately reflect the actual radio frequency environment associated with the future deployment of that cell.

Stated differently, the cell deployment optimization engine can provide enhanced predictions related to enhanced location determinations for the cell to be deployed (e.g., a predicted revenue stream amounts per year based on deploying a cell at a proposed cell deployment location, a predicted return on investment based on deploying a cell at a proposed cell deployment location, a number of predicted small cells that satisfy coverage and capacity thresholds for proposed cell deployment location(s), geospatial maps (e.g., interactive geospatial maps, extended reality geospatial maps) for each proposed cell and associated cell deployment location, predicted cumulative churn probability predictions for each proposed cell and associated cell deployment location, etc., or one or more combinations thereof). As another example, the cell deployment optimization engine can provide enhanced predictions that improve user device experiences and reduce churn (e.g., based on deploying cells at proposed cell deployment locations, based on deploying cells that capture a predicted number of internet devices (e.g., fixed wireless access devices, high speed internet devices, etc.).

Based on these enhanced predictions, the cell deployment optimization techniques described herein can provide each of the improvements noted above.

In an embodiment, a cell deployment optimization engine is provided. The cell deployment optimization engine may comprise one or more processors and computer memory storing computer-usable instructions that, when executed by the one or more processors, cause the one or more processors to perform operations. For example, the operations may comprise receiving a proposed cell deployment location. The operations may also comprise determining a user experience for subscribers located within a threshold distance of the proposed cell deployment location. The operations may also comprise determining a user experience adjustment to the user experience for the subscribers based on deploying a cell at the proposed cell deployment location. The operations may also comprise comparing the user experience adjustment to a churn rate and providing a cell deployment prediction based on comparing the user experience adjustment to the churn rate.

In another embodiment, a method for cell deployment optimization is provided. The method may comprise receiving a proposed cell deployment location. The method may also comprise determining a user experience for subscribers located within a threshold distance of the proposed cell deployment location. The method may also comprise determining a user experience adjustment to the user experience by applying a home coverage deduction, the home coverage deduction determined based on the proposed cell deployment location, a home coverage location for each of the subscribers, and predicted cell coverage data upon deploying a cell at the proposed cell deployment location. The method may also comprise comparing the user experience adjustment to a churn rate and providing a cell deployment prediction based on comparing the user experience adjustment to the churn rate.

In another example embodiment, one or more computer storage media having computer-executable instructions embodied thereon, that when executed by at least one processor, cause the at least one processor to perform a method. The method may comprise determining a user experience for subscribers having historical location data within a threshold distance of a proposed cell deployment location. The method may also comprise determining a user experience adjustment to the user experience for the subscribers based on deploying a cell at the proposed cell deployment location and providing a cell deployment prediction based on the user experience adjustment.

### Example Operating Environment

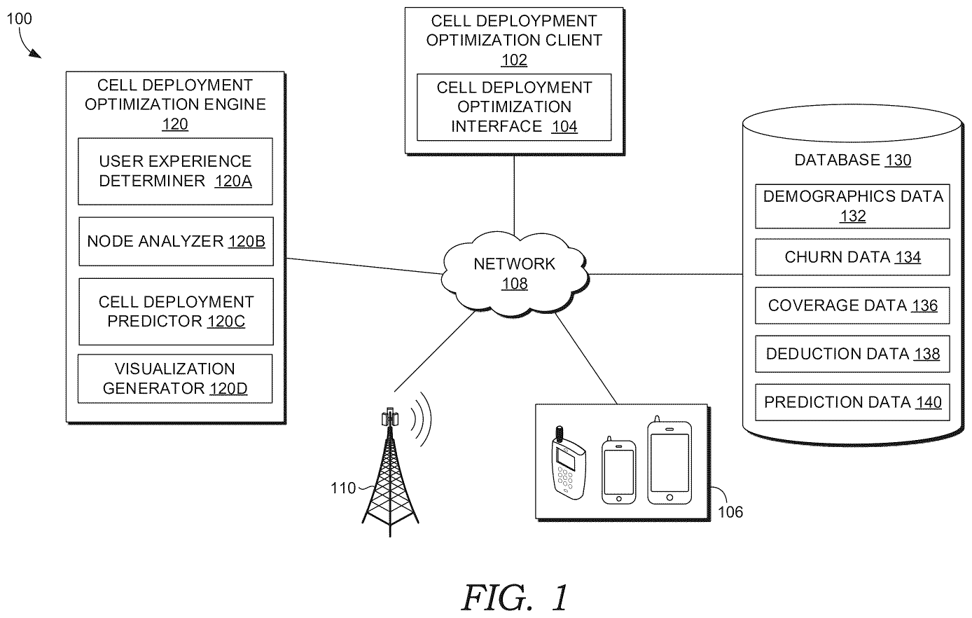

Turning now to FIG. 1, example operating environment 100 is illustrated in accordance with one or more embodiments disclosed herein. At a high level, the example operating environment 100 comprises cell deployment optimization client 102 including cell deployment optimization interface 104; user devices 106; network 108; base station 110; cell deployment optimization engine 120 including user experience determiner 120A, node analyzer 120B, cell deployment predictor 120C, and visualization generator 120D; and database 130 including demographics data 132, churn data 134, coverage data 136, deduction data 138, and prediction data 140.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional cell deployment optimization clients or other configurations of the database 130 (e.g., database 130 may be a distributed computing environment encompassing multiple computing devices for storing one or more of the demographics data 132, churn data 134, coverage data 136, deduction data 138, and prediction data 140).

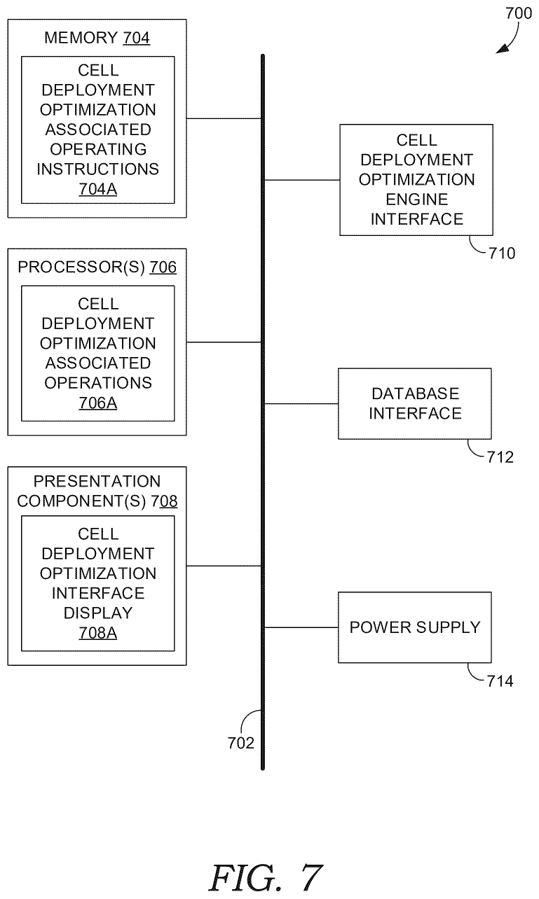

Cell deployment optimization client 102 may be a device that has the capability of communicating (e.g., transmitting or receiving one or more signals to or from) with one or more of the base station 110, cell deployment optimization engine 120, and database 130 over the network 108. In some embodiments, the cell deployment optimization client 102 or one or more of the user devices 106 may be a “user device,” “computing device,” “mobile device,” “client,” “user equipment (UE),” or “wireless communication device.” In some embodiments, the cell deployment optimization client 102 may be a server. The cell deployment optimization client 102 or one or more of the user devices 106, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108. In some embodiments, the cell deployment optimization client 102 may be example cell deployment optimization client 700 described herein with respect to FIG. 7.

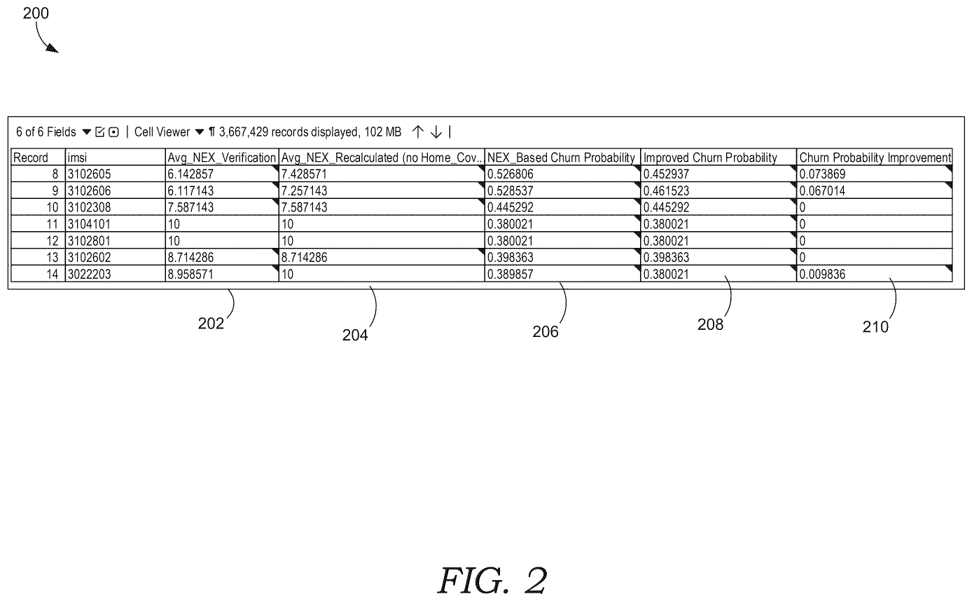

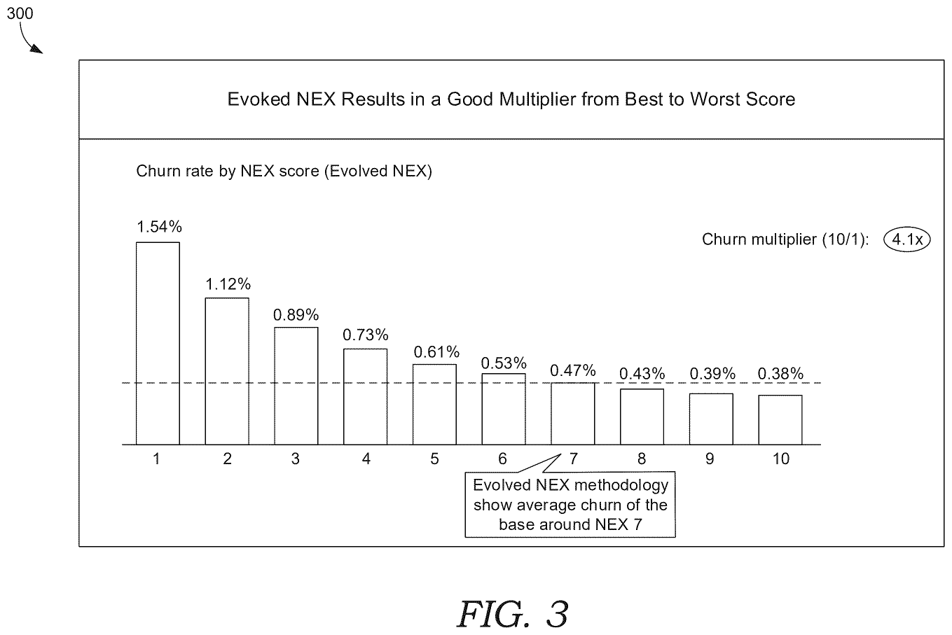

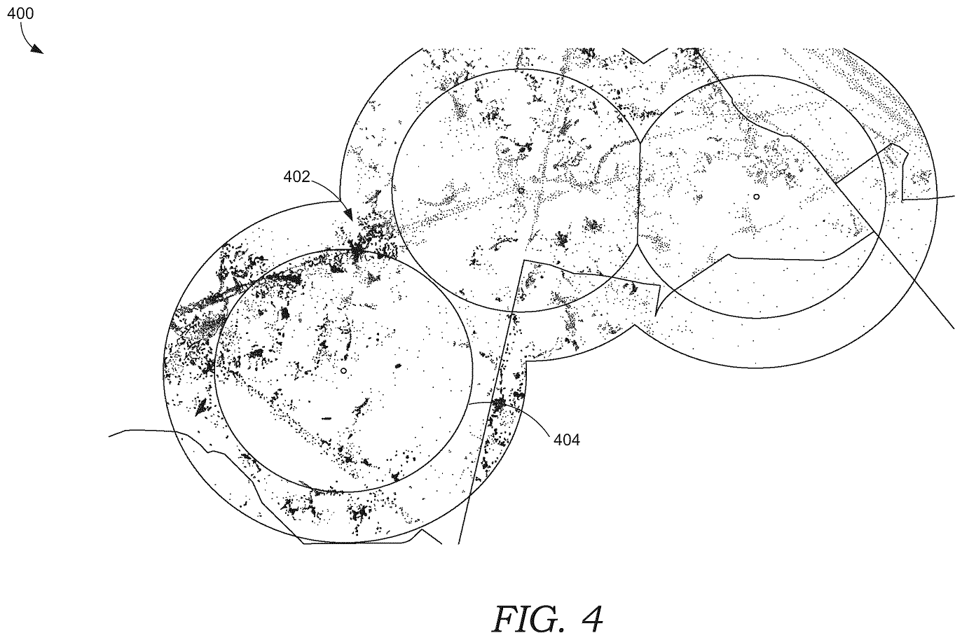

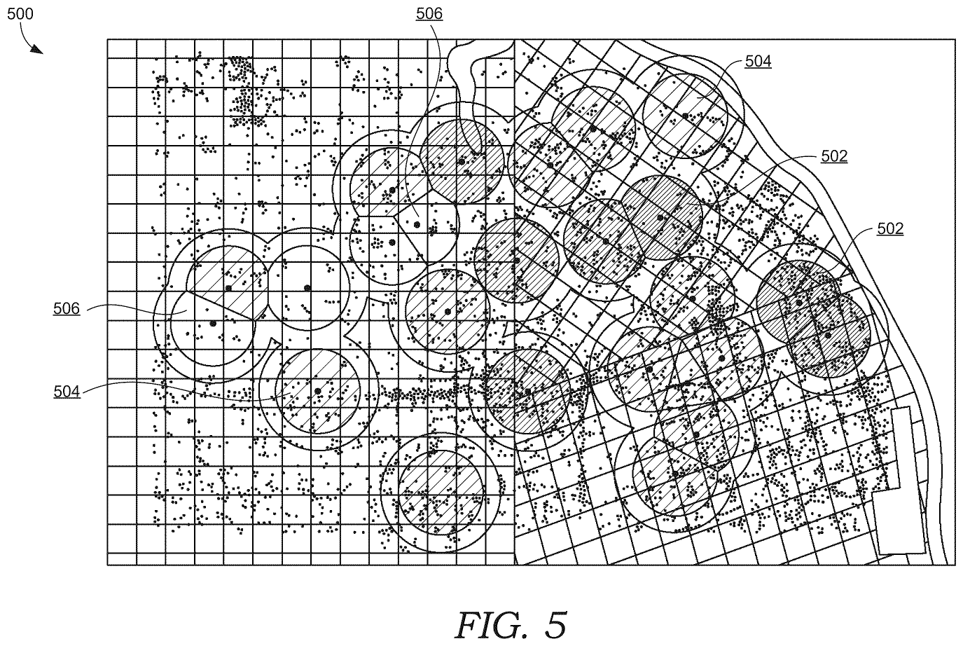

The cell deployment optimization client 102 may be, in an embodiment, capable of providing for display, via the cell deployment optimization interface 104 (e.g., via presentation component(s) 708 of FIG. 7), one or more data items stored within database 130 (e.g., the demographics data 132, churn data 134, coverage data 136, deduction data 138, and prediction data 140), example table 200 of FIG. 2 (or a portion thereof), example graph 300 of FIG. 3, example graphical display 400 of FIG. 4, example graphical display 500 of FIG. 5, user experiences and user experience adjustments, cell deployment predictions, other types of cell deployment optimization engine output, etc., or one or more combinations thereof.

In embodiments, the cell deployment optimization interface 104 may be one or more presentation component(s) 708 of FIG. 7. In embodiments, the cell deployment optimization interface 104 may display image data, text data, extended reality data, other types of data, or one or more combinations thereof, based on one or more operations of the cell deployment optimization engine 120 (e.g., operations associated with the user experience determiner 120A, node analyzer 120B, cell deployment predictor 120C, and visualization generator 120D, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., cell deployment optimization client 102, base station 110, cell deployment optimization engine 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof.

In embodiments, the base station 110 may be a macro cell or another type of cell (e.g., a micro cell, a picocell, femtocell, small cell, microcell, an indoor cell (e.g., a small cell or femtocell), a distributed antenna system (e.g., a network of distributed antennas connected to a central source), a remote radio head, etc.). In embodiments, the base station 110 may be a station that communicates with the user devices 106, the cell deployment optimization engine 120, the cell deployment optimization client 102, etc., and may, in some implementations, be an evolved node B (eNB), a next generation eNB (gNB), an access point, etc., or one or more combinations thereof. The base station 110 may provide communication coverage for a particular geographical coverage area.

In 3GPP, the term “cell” can include a particular geographic coverage area of the base station (or a base station subsystem serving the coverage area). In some embodiments, the base station 110 may be associated with a same operator or different operators, such as the example operating environment 100 may include one or more operator wireless networks. For example, a “subscriber” may refer to a user device that subscribes to services (e.g., telecommunication services) provided by a particular operator. In embodiments, the base station 110 may provide communication services via one or more frequency bands in licensed spectrum, unlicensed spectrum, etc., or one or more combinations thereof.

In embodiments, data stored within the database 130 may be stored based on base station 110 communications. In some embodiments, the database 130 may include subscriber data, such as behavior patterns of the user devices 106 (e.g., associated with handover events, location data for user devices 106 based on cell identities and timing advance, call logs including duration, frequency, and timing, services accessed, data usage), International Mobile Equipment Identity (IMEI) for the user devices 106, International Mobile Subscriber Identity (IMSI) for the user devices 106, Mobile Country Code (MCC), Mobile Network Code (MNC), technologies (e.g., 5G) that the user devices 106 support, subscriber registration data, demographics data (e.g., age, gender, and address), mobility patterns, peak usage times and areas, etc., or one or more combinations thereof. As another example, the churn data 134 may include call log frequency and duration, data usage patterns, messaging service usages, types of applications used, customer support interaction data, service issue reports, dropped call frequencies of the user devices 106, poor signal quality indications, etc., or one or more combinations thereof.

In yet another example, the coverage data 136 may include Received Signal Strength Indicator (RSSI), Reference Signal Received Power (RSRP), Reference Signal Received Quality (RSRQ), Signal to Interference plus Noise Ratio (SINR), Channel Quality Indicator (CQI), timing advance, Physical Cell Identity (PCI), Cell Identity, frequency band usage, Absolute Radio Frequency Channel Number (ARFCN), tracking area code, etc., or one or more combinations thereof.

In some embodiments, the coverage data 136 may include user devices 106 having an RSSI below a threshold, RSRP below a threshold, RSRQ below a threshold, SINR below a threshold, CQI below a threshold, etc., or one or more combinations thereof. In embodiments, RSSI data within the database 130 may be linked to a particular PCI, timing advance, Cell Identity, frequency band usage, ARFCN, tracking area code, etc., or one or more combinations thereof. In embodiments, RSRQ data within the database 130 may be linked to a particular PCI, timing advance, Cell Identity, frequency band usage, ARFCN, tracking area code, etc., or one or more combinations thereof. In embodiments, RSRP data within the database 130 may be linked to a particular PCI, timing advance, Cell Identity, frequency band usage, ARFCN, tracking area code, etc., or one or more combinations thereof. In embodiments, CQI data or SINR data within the database 130 may be linked to a particular PCI, timing advance, Cell Identity, frequency band usage, ARFCN, tracking area code, etc., or one or more combinations thereof.

In embodiments, the cell deployment optimization engine 120 may comprise computing devices (e.g., one or more servers). In some embodiments, the cell deployment optimization engine 120 may be a single server, a distributed computing environment encompassing multiple computing devices located at the same physical geographical location or at different physical geographical locations, another type of server environment, etc. In embodiments, the cell deployment optimization engine 120 may comprise one or more processors, one or more electronics devices, one or more hardware devices, one or more electronics components, one or more logical circuits, one or more memories, one or more software codes, one or more firmware codes, etc., or one or more combinations thereof.

The cell deployment optimization engine 120 may access the database 130 to execute tasks (e.g., associated with the user experience determiner 120A, node analyzer 120B, cell deployment predictor 120C, and visualization generator 120D, etc.). For example, a user—via the cell deployment optimization client 102 (e.g., via the cell deployment optimization interface 104)—may transmit a request to communicate with the cell deployment optimization engine 120. The cell deployment optimization engine 120 may receive, retrieve, analyze, and store the demographics data 132, churn data 134, coverage data 136, deduction data 138, and prediction data 140 at/from the database 130.

In some embodiments, the cell deployment optimization engine 120 may determine user experiences via the user experience determiner 120A. For example, a user experience may correspond to an experience of each of the user devices 106 associated with communications over the network 108 with the base station 110. The user experience may correspond to utilizing a telecommunication service of a particular operator associated with the base station 110. In embodiments, the user experience determiner 120A may determine user experiences for the user devices 106, wherein each of the user devices 106 are subscribers of the particular operator associated with the base station 110. In embodiments, the user experiences may correspond to a quality or performance associated with a communication service of a particular operator associated with the base station 110. In embodiments, the user experience may correspond to connectivity, data speed(s), call quality, latency, reliability, etc., associated with accessing the network 108.

In embodiments, the user experience determiner 120A determines a user experience for each International Mobile Subscriber Identity (IMSI) associated with each user device 106 subscriber. In some embodiments, the user experience for each IMSI corresponds to column 202 in example table 200 of FIG. 2. In embodiments, the user experience determined by the user experience determiner 120A may correspond to coverage data 136 associated with the base station 110 and network 108, as well as other access nodes that a particular IMSI has utilized over a period of time for access to the network 108. For example, the user experience may correspond to latency data associated with Cell Identities and a particular IMSI.

In some embodiments, such as illustrated by column 202 in example table 200 of FIG. 2, a value for a determined user experience may be lower for a user device experiencing higher latency at a particular location and higher dropped call rates at the particular location. By way of illustration, the user experiences in column 202 in example table 200 of FIG. 2 that have a value of 10 have a better user experience than the IMSI user devices that have the lower values in column 202. As another illustration, user devices experiencing a higher data leakage value corresponding to data transmissions to an unauthorized recipient would have a lower user experience value.

In some embodiments, a value for a determined user experience may be lower for a user device experiencing a lower average air interface throughput associated with successful data transfers between the user device and base station 110 over the wireless air interface over a particular period of time. As another example, a user device that experiences handovers at a higher rate for a particular period of time may have a lower user experience value. By way of example, in other embodiments, the user experiences may be indicated by a color instead of a particular value. The cell deployment optimization interface 104 may, in some embodiments, display the user experiences generated by the user experience determiner 120A of the cell deployment optimization engine 120.

In embodiments, the user experience determiner 120A determines a user experience for subscribers (e.g., user devices 106) located within a threshold distance of a proposed cell deployment location. For example, in some embodiments, the proposed cell deployment location may correspond to a proposed location for macro cell, a picocell, femtocell, small cell, microcell, or another type of cell, etc. In some embodiments, the proposed cell deployment location may be received from cell deployment optimization client 102. In some embodiments, the cell deployment optimization engine 120 identifies one or more proposed cell deployment locations using a cell site auto-placement algorithm (e.g., based on deduction data 138).

The user experience determiner 120A can also determine user experience adjustments. By way of example, user experience adjustments may be determined for subscribers based on deploying a cell at a future time at the proposed cell deployment location. In some embodiments, the user experience adjustment may be determined for the subscribers based on deploying the cell at each of the plurality of proposed cell deployment locations. In some embodiments, the user experience adjustment may be the user experience adjustments in column 204 of example table 200 of FIG. 2. In embodiments, the user experience adjustment may be applied to user devices having user experiences below a threshold or areas within the graphical display 400 of nodes of FIG. 4 associated with areas 402 and the user devices having the user experiences below the threshold.

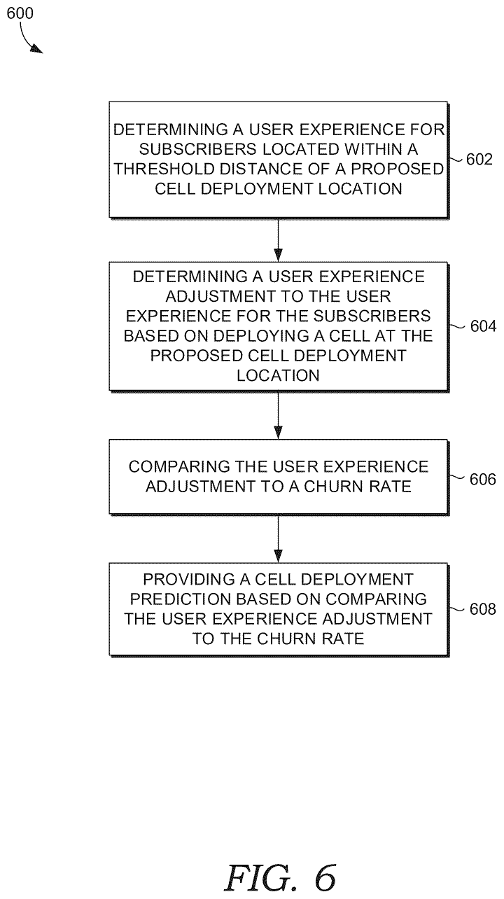

In embodiments, the user experience adjustment may be determined using the database 130. For example, user devices within a residential area (e.g., based on user device location data, demographics data 132 including census data from census databases) experiencing particular user experiences may have improved user experience adjustments (e.g., improved network coverage data, improved latencies, improved home coverage, improved leakage) based on a future deployment of the cell at the proposed cell location. In some embodiments, the user experience adjustment may be determined using echolocation data, Wi-Fi availability associated with each of the user devices 106, roaming data associated with historical location of the user devices, currently implemented cells and backhauls, etc., or one or more combinations thereof. In embodiments, the user experience adjustment may be determined as explained within the discussion for step 604 of FIG. 6.

In embodiments, node analyzer 120B may analyze and aggregate demographics data 132, churn data 134, coverage data 136, deduction data 138, prediction data 140, etc., on a node by node basis. For example, visualization generator 120D may generate example graphical display 400 of FIG. 4 that includes nodes corresponding to coverage data 136 for previously deployed cells (e.g., base station 110), and the node analyzer 120B may analyze and adjust demographics data 132, churn data 134, coverage data 136, deduction data 138, prediction data 140, etc., associated with each of the nodes of example graphical display 400, or portions thereof. For example, the node analyzer 120B may adjust demographics data 132, churn data 134, and coverage data 136 to generate the deduction data 138 based on predictions of improvements to the churn data 134 and coverage data 136 based on deploying a cell at a proposed cell location.

Based on the example graphical display 400 of FIG. 4, the node analyzer 120B may analyze areas 402 associated with user devices having a user experiences below a threshold, and areas 402 associated with user devices having a user experiences above the threshold. For example, the node analyzer 120B may extrapolate echolocation data generated by each of the user devices within areas 402, and may extrapolate echolocation data generated by each of the user devices within areas 404. As another example, the node analyzer 120B may identify the subscribers within areas 402 and 404 based on each of the subscribers being located within each of these corresponding areas for a threshold period of time. As another example, the node analyzer 120B may determine home coverage locations for each of the user devices within each of the areas 402 and 404, and the home coverage locations may be stored as subscriber data.

In embodiments, the cell deployment optimization engine 120 can use churn data 134 (e.g., based on using predictions of users who no longer churn in response to deploying the cell and an aggregation of the churn probability of the improvements predicted) to generate one or more columns of FIG. 2. For example, column 204 of FIG. 2 may be determined for each user device or subscriber, such that the determinations are compared for generating the example graph 300 of FIG. 3. To illustrate, column 204 of FIG. 2 may be used for determining enhanced churn probabilities, such as illustrated in column 208 of FIG. 2 (e.g., the improvement measurements to the churn predictions being illustrated in column 210). Stated differently, the example graph 300 of FIG. 3 illustrates a best-fit curve among all the bars (e.g., such that the percentages represented by the bar graphs do not change), which may be converted into a formula that may be applied to one or more columns of FIG. 2 to determine an improvement in churn probability for each user device or subscriber. By way of illustration, FIG. 3 illustrates a churn probability, and the the cell deployment optimization engine may determine a location among the bar graphs as to where a user device or subscriber falls (i.e., the probability of churn) upon an improvement to a corresponding coverage.

In embodiments, visualization generator 120D may generate example graphical displays to provide a visual output for different scenarios corresponding to different proposed cell deployment locations (e.g., assuming a particular cell type having a particular coverage radius). For example, the visualization generator 120D may generate example graphical display 500 of FIG. 5 that includes predicted cell deployment coverage data for proposed cell deployment locations. In embodiments, visualization generator 120D may generate example graphical display 500 of FIG. 5 based on example table 200 of FIG. 2 (or a portion thereof), example graph 300 of FIG. 3, example graphical display 400 of FIG. 4, etc. In embodiments, each node within example graphical display 500 of FIG. 5 may correspond to a coverage area for each of a plurality of proposed cell deployment locations. In embodiments, each node within example graphical display 500 of FIG. 5 may indicate a number of the subscribers corresponding to the coverage area. For example, nodes 502 may indicate a higher number of subscribers within that associated coverage area than the number of subscribers within nodes 504, and higher than the number of subscribers within nodes 506. As another example, nodes 504 may indicate a higher number of subscribers within that associated coverage area than the number of subscribers within nodes 506.

In some embodiments, the prediction data 140 (e.g., churn predictions associated with churn enhancements based on a future deployment of a cell that provides an assumed coverage upon deployment within a default coverage radius, churn enhancement predictions and other gains within that radius, etc.) may be determined using the cell deployment predictor 120C. For example, the cell deployment predictor 120C may apply deduction data 138 to the churn data 134. By way of example, in embodiments, cell deployment predictions may include aggregated average churn probability improvements (e.g., churn probability improvements in column 208 and 210 of FIG. 2) associated with each node (e.g., the nodes of FIG. 4 associated with coverage data for previously deployed cells or node clusters based on a sum total of households within the coverage area for the cell to be deployed. For example, the prediction data 140 may be used to generate the nodes of FIG. 5 associated with predicted cell deployment coverage data for proposed cell deployment locations. In some embodiments, the prediction data 140 may be stored within prediction data 140.

### Example Flowchart

FIG. 6 includes flowchart 600, which begins at step 602 with determining a user experience (e.g., determined by user experience determiner 120A of FIG. 1; user experiences in column 202 of example table 200 of FIG. 2) for subscribers located within a threshold distance (e.g., a 250 meter radius) of a proposed cell deployment location (e.g., a cell, such as a macro cell, small cell, etc., to be deployed at a future time). In embodiments, the proposed cell deployment location may be received from the cell deployment optimization client 102 of FIG. 1 or the cell deployment optimization client 700 of FIG. 7.

In some embodiments, the subscribers may be identified based on each of the subscribers being located within the threshold distance for a threshold period of time. In some embodiments, the subscribers may be identified based on demographics data 132. In some embodiments, the subscribers may be identified based on each of the subscribers having the user experience include coverage data (e.g., coverage data 136) that is below a threshold.

In some embodiments, the subscribers are identified based on each of the subscribers having the user experience include coverage data—associated with the proposed cell deployment location—that is below a threshold (i.e., coverage data from a previously deployed cell that corresponds to an anticipated coverage area for the cell to be deployed at the proposed cell deployment location). In some embodiments, the user experience for the subscribers is determined based on historical location data for the subscribers and based on historical coverage data for the subscribers while located within the threshold distance of the proposed cell deployment location.

In some embodiments, non-subscribers may be identified based on each of the non-subscribers having historical location data within the threshold distance of the proposed cell deployment location. In some embodiments, interference data may be identified from a previously deployed cell (e.g., base station 110 of FIG. 1), the interference data being associated with the proposed cell deployment location and the predicted coverage area for a cell to be in deployed.

Step 604 includes determining a user experience adjustment to the user experience for the subscribers based on deploying a cell at the proposed cell deployment location. Stated differently, the user experience adjustment may be determined based on deployment of the cell in the future. In some embodiments, the user experience adjustment may be determined based on deploying the cell at each of a plurality of proposed cell deployment locations. In some embodiments, user experience adjustments may be determined by the user experience determiner 120A (e.g., based on changes to one or more of the churn data 134 or the coverage data 136 upon future implementation of the cell at the proposed cell deployment location).

In some embodiments, user experience adjustments may be determined for non-subscribers based on deploying the cell at the proposed cell deployment location. In some embodiments, the user experience adjustment to the user experience may include applying a home coverage deduction (e.g., deduction data 138 of FIG. 1) to a churn rate for each of the subscribers. For example, the home coverage deduction may be determined based on the proposed cell deployment location, a home coverage location for each of the subscribers, and predicted cell coverage data upon deploying the cell at the proposed cell deployment location. In some embodiments, user experience adjustments may be the user experience adjustments in column 204 of example table 200 of FIG. 2.

Step 606 includes comparing the user experience adjustment to a churn rate (e.g., a measure of the proportion of subscribers becoming non-subscribers over a particular period of time). For example, a churn rate may refer to number of churned subscribers compared to the total number of subscribers. To illustrate, a higher churn rate may indicate that subscribers are having an unsatisfactory user experience.

In embodiments, comparing the user experience adjustment to the churn rate may include determining a probability of improvement in the churn rate (e.g., for each subscriber, for each non-subscriber). By way of example, the probability of improvement in the churn rate may correspond to an enhancement from 0.5 to 0.4 in the churn rate. As another example, the churn rate may correlate to a propensity of each user of the user device to churn (e.g., captured for each individual user each day and updated each month). In embodiments, comparing the user experience adjustment to the churn rate may include aggregating or applying the improvements, associated with each subscriber in response to a future deployment of the cell at the proposed cell deployment location, with a churn rate for each of the user devices frequenting the coverage area corresponding to the future deployment of the cell. In some embodiments, the comparison of the user experience adjustment to the churn rate may be correlated to a dollar amount savings associated with the churn improvement upon deployment of the cell (e.g., aggregating user experiences of individual users who have current coverage data below a threshold, and applying a predicted revenue stream of churn avoidance upon deploying the cell).

As noted above, comparing the user experience adjustment to the churn rate may include determining a probability of improvement in the churn rate. For example, particular deductions may be applied to the churn rate (e.g., deduction data 138 of FIG. 1). To illustrate, a home coverage deduction may be applied to the churn rate, the home coverage deduction determined based on the proposed cell deployment location, a home coverage location (e.g., for each of the subscribers, for non-subscribers, for particular users having user experiences below a threshold, etc.), and predicted cell deployment coverage data. In embodiments, the predicted cell deployment coverage data may be based on applying adjustments to historical coverage data for a particular area using user device feedback from user devices that frequented that area during a particular month. In embodiments, home coverage locations may be determined using historical location data of the user devices, national census database(s), regional and local census database(s), geographic information system(s), other types of demographics databases, etc., or one or more combinations thereof.

In some embodiments, the home coverage data and a home coverage deduction may be determined (e.g., for each of the subscribers) based on linking network experience scores (e.g., network experience scores previously indexed) and associated data per each user (e.g., per each user device) with an associated time and day that the user device reported measurements. In embodiments, user device measurements reported within a certain timeframe (e.g., at night and early morning) may be used as the home coverage data. In some embodiments, a number of households (e.g., extracted from census data) may also be used as subscription data (e.g., associated with high speed internet devices) for proposed cell location determinations.

In some embodiments, home coverage deduction may be determined based on applying a geospatial analysis technique to extract a number of households (e.g., per small cell footprint, per macro cell footprint, per microcell footprint) from census blocks data corresponding to deploying the cell at the proposed cell deployment location. For example, a geospatial analysis technique may comprise the collection, processing, and analysis of spatial data for geographic locations. In embodiments, the spatial data may be retrieved or collected via remote sensing techniques (e.g., satellite or aerial imagery), global positioning techniques, ground-based methods for collecting spatial data, geo-referencing, spatial interpolation, spatial clustering, hotspot analyses, spatial overlays, etc., or one or more combinations thereof. In embodiments, the census blocks data may be generated using demographics data 132 of FIG. 1, geospatial data processing (e.g., using shape-files, projection and coordinate systems, data cleaning and formatting, attribute joining, spatial aggregation, geospatial software tools, attribute assignment).

Based on applying the geospatial analysis technique, echolocation data may be extrapolated for a coverage area corresponding to deploying the cell at the proposed cell deployment location. By way of example, the echolocation data may comprise signal measurements and spatial data (e.g., generated by user devices based on a probe of the user device for periodic back signal measurement reports or location information reports). The echolocation data may be associated with geographical location data, object locations within a geographical location, performance of user devices and network infrastructure, network component locations, etc. In some embodiments, comparing the user experience adjustment to the churn rate may include applying a latency deduction to the churn rate, the latency deduction determined based on the proposed cell deployment location, the home coverage location for each of the subscribers, and the predicted cell coverage data upon deploying the cell at the proposed cell deployment location. In some embodiments, comparing the user experience adjustment to the churn rate may include applying a leakage deduction to the churn rate.

At step 608, a cell deployment prediction may be provided based on comparing the user experience adjustment to the churn rate. In embodiments, the cell deployment prediction may be based on predicted interference data from a previously deployed cell and based on applying a predicted deduction to a churn rate. In embodiments, the cell deployment prediction may be provided by generating and displaying a graphical display of one or more nodes corresponding to predicted coverage areas for the proposed cell deployment location(s) (e.g., FIG. 5). In some embodiments, the graphical display may indicate a number of the subscribers corresponding to the coverage area. In some embodiments, the graphical display may indicate a particular population during a particular time of day, associated census data, and the user experience adjustments may be aggregated on a node-by-node basis.

In embodiments, cell deployment predictions may include aggregated average churn probability improvements for each node or for node clusters based on a sum total of households within the coverage area for the cell to be deployed, based on a total population for the coverage area, a number of currently underserved user devices (e.g., for each IMSI) for the coverage area, a number of user devices frequenting within the coverage area, predicted non-subscribers captured upon deployment of the cell, improved churn predictions for subscribers upon deployment of the cell, an amount of savings per year upon deployment of the cell, a minimum indoor coverage threshold (e.g., −105 dBm), a minimum outdoor coverage threshold (e.g., −110 dBm), a comparison of subscribers and non-subscribers for the coverage area, a comparison of currently underserved subscribers to currently underserved non-subscribers, a predicted number of cells for a particular region, echolocation correction factors associated with deployment of the cell, investment costs associated with deployment of the cell, a cost associated with time-to-market, etc.

### Example Cell Deployment Optimization Client

Referring now to FIG. 7, a diagram is depicted of an example cell deployment optimization client suitable for use in implementations of the present disclosure. In particular, the example cell deployment optimization client is shown and designated generally as cell deployment optimization client 700. Example cell deployment optimization client 700 is but one example of a suitable computing environment and is not intended to suggest any limitation as to the scope of use or functionality of the invention. Neither should cell deployment optimization client 700 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, cell deployment optimization client 700 includes bus 702 that directly or indirectly couples the following devices: memory 704, one or more processors 706, one or more presentation components 708, cell deployment optimization engine interface 710, database interface 712, and power supply 714. The memory 704 may include cell deployment optimization associated operating instructions 704A, which may be executed by the processor(s) 706 to perform cell deployment optimization associated operations 706A. The one or more presentation components 708 may include cell deployment optimization interface display 708A.

Although the components of FIG. 7 are shown with lines for the sake of clarity, in reality, delineating various components is not so clear, and metaphorically, the lines would more accurately be grey and fuzzy. For example, processors, such as one or more processors 706, have memory. The present disclosure hereof recognizes that such is the nature of the art, and reiterates that FIG. 7 is merely illustrative of an example cell deployment optimization client 700 that may be used in connection with one or more implementations of the present disclosure.

In some embodiments, the cell deployment optimization client 700 may be a “workstation,” “server,” “laptop,” “handheld device,” “computing device,” etc. In some embodiments, the cell deployment optimization client 700 may be cell deployment optimization client 102 of FIG. 1.

In some embodiments, bus 702 may represent what may be one or more busses (such as an address bus, data bus, or a combination thereof).

The cell deployment optimization client 700 may include a variety of computer-readable media. Computer-readable media may be any available media that may be accessed by cell deployment optimization client 700 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 704 includes computer-storage media in the form of volatile and/or nonvolatile memory. Memory 704 may be removable, non-removable, or a combination thereof. Examples of memory 704 may include solid-state memory, hard drives, optical-disc drives, etc., or one or more combinations thereof.

Example cell deployment optimization client 700 also includes one or more processors 706 that read data from one or more entities, such as bus 702, memory 704, one or more presentation components 708, cell deployment optimization engine interface 710, database interface 712, or power supply 714. In embodiments, the cell deployment optimization engine interface 710 may be cell deployment optimization interface 104 of FIG. 1. In embodiments, the cell deployment optimization client 700 may communicate with database 130 of FIG. 1 via the database interface 712.

Examples of one or more processors 706 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

The processor(s) 706 may perform cell deployment optimization associated operations 706A. For example, the cell deployment optimization associated operations 706A may include receiving or identifying proposed cell deployment locations, causing the determinations of user experiences for user devices having historical location data within a threshold distance of the proposed cell deployment location, causing the determinations of user experience adjustments to the user experiences based on predictions for deploying a cell at a proposed cell deployment location, retrieving data from databases using the cell deployment optimization engine interface 710, performing operations based on cell deployment predictions determined based on the user experience adjustments, etc., or one or more combinations thereof. In embodiments, the cell deployment optimization associated operations 706A may include causing one or more of the steps (or portions thereof) discussed above with respect to FIG. 6.

One or more presentation components 708 may present (e.g., to a person or other device) various data instances (e.g., based on operations of the cell deployment optimization engine 120 of FIG. 1). Examples of the one or more presentation components 708 may include a display device, speaker, printing component, vibrating component, etc. In some embodiments, the one or more presentation components 708 may present data received via the cell deployment optimization engine interface 710 or the database interface 712.

In some embodiments, the cell deployment optimization interface display 708A may display example table 200 of FIG. 2 (or a portion thereof), the example graph 300 of FIG. 3, the example graphical display 400 of FIG. 4, the example graphical display 500 of FIG. 5, user experiences and user experience adjustments, cell deployment predictions, other types of cell deployment optimization engine output, etc., or one or more combinations thereof.

In some embodiments, the cell deployment optimization interface display 708A may display predicted revenue stream amounts per year based on deploying a cell at a proposed cell deployment location, a predicted return on investment based on deploying a cell at a proposed cell deployment location, a number of predicted small cells that satisfy coverage and capacity thresholds for proposed cell deployment location(s), geospatial maps (e.g., interactive geospatial maps, extended reality geospatial maps) for each proposed cell and associated cell deployment location, predicted cumulative churn probability predictions for each proposed cell and associated cell deployment location, etc., or one or more combinations thereof.

In embodiments, the cell deployment optimization client 700 facilitates communication with a wireless telecommunications network (e.g., via a radio). Illustrative wireless telecommunications technologies may include CDMA, GPRS, TDMA, GSM, and the like. The cell deployment optimization client 700 might additionally or alternatively facilitate other types of wireless communications including Wi-Fi, WiMAX, LTE, or other VOIP communications. As can be appreciated, in various embodiments, the cell deployment optimization client 700 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A cell deployment optimization engine comprising:
one or more processors; and
computer memory storing computer-usable instructions that, when executed by the one or more processors, cause the one or more processors to perform operations comprising:
receiving a proposed cell deployment location;
determining a user experience for subscribers located within a threshold distance of the proposed cell deployment location;
determining a user experience adjustment to the user experience for the subscribers based on deploying a cell at the proposed cell deployment location;
comparing the user experience adjustment to a churn rate; and
providing a cell deployment prediction based on comparing the user experience adjustment to the churn rate.

2. The cell deployment optimization engine according to claim 1, the operations further comprising:
identifying the subscribers based on each of the subscribers being located within the threshold distance for a threshold period of time; and
determining the cell deployment prediction by applying a home coverage deduction to the churn rate, the home coverage deduction determined based on the proposed cell deployment location, a home coverage location for each of the subscribers, and predicted cell deployment coverage data.

3. The cell deployment optimization engine according to claim 2, the operations further comprising determining the cell deployment prediction by applying a latency deduction to the churn rate, the latency deduction determined based on the proposed cell deployment location and the predicted cell deployment coverage data.

4. The cell deployment optimization engine according to claim 1, the operations further comprising identifying the subscribers based on each of the subscribers having the user experience include coverage data that is below a threshold.

5. The cell deployment optimization engine according to claim 1, the operations further comprising:
receiving a plurality of proposed cell deployment locations including the proposed cell deployment location;
determining the user experience for the subscribers located within the threshold distance of each of the plurality of proposed cell deployment locations;
determining the user experience adjustment for the subscribers based on deploying the cell at each of the plurality of proposed cell deployment locations;
comparing the user experience adjustment to the churn rate; and
based on comparing the user experience adjustment to the churn rate for each of the plurality of proposed cell deployment locations, providing a graphical display of nodes, each node corresponding to a coverage area for each of the plurality of proposed cell deployment locations, each node in the graphical display indicating a number of the subscribers corresponding to the coverage area.

6. The cell deployment optimization engine according to claim 1, the operations further comprising determining the user experience for the subscribers based on historical location data for the subscribers.

7. The cell deployment optimization engine according to claim 6, the operations further comprising determining the user experience for the subscribers based on historical coverage data for the subscribers while located within the threshold distance of the proposed cell deployment location.

8. A method for cell deployment optimization, the method comprising:
receiving a proposed cell deployment location;
determining a user experience for subscribers located within a threshold distance of the proposed cell deployment location;
determining a user experience adjustment to the user experience;
comparing the user experience adjustment to a churn rate by a home coverage deduction to the churn rate, the home coverage deduction determined based on the proposed cell deployment location, a home coverage location for each of the subscribers, and predicted cell coverage data upon deploying a cell at the proposed cell deployment location; and
providing a cell deployment prediction based on comparing the user experience adjustment to the churn rate.

9. The method according to claim 8, further comprising determining the home coverage deduction for each of the subscribers based on applying a geospatial analysis technique to extract a number of households per small cell footprint from census blocks data corresponding to deploying the cell at the proposed cell deployment location.

10. The method according to claim 9, further comprising:
based on applying the geospatial analysis technique, extrapolating echolocation data for a coverage area corresponding to deploying the cell at the proposed cell deployment location; and
based on extrapolating the echolocation data, providing a graphical display of a node corresponding to the coverage area for the proposed cell deployment location, the graphical display indicating a number of the subscribers corresponding to the coverage area.

11. The method according to claim 10, further comprising:
identifying the subscribers based on each of the subscribers having the user experience include coverage data associated with the proposed cell deployment location that is below a threshold.

12. The method according to claim 11, further comprising:
identifying non-subscribers based on each of the non-subscribers having historical location data within the threshold distance of the proposed cell deployment location;
determining user experiences for the non-subscribers;
determining user experience adjustments to the user experiences for the non-subscribers based on deploying the cell at the proposed cell deployment location; and
providing the cell deployment prediction based on the user experience adjustments for the non-subscribers.

13. The method according to claim 12, further comprising applying the home coverage deduction to the churn rate for the non-subscribers based the home coverage location for each of the non-subscribers and the predicted cell coverage data upon deploying the cell at the proposed cell deployment location.

14. The method according to claim 13, further comprising providing the cell deployment prediction based on applying the home coverage deduction to the churn rate for the non-subscribers.

15. One or more computer storage media having computer-executable instructions embodied thereon, that when executed by at least one processor, cause the at least one processor to perform a method comprising:
receiving a proposed cell deployment location;
determining a user experience for subscribers having historical location data within a threshold distance of the proposed cell deployment location;
determining a user experience adjustment to the user experience for the subscribers based on deploying a cell at the proposed cell deployment location; and
providing a cell deployment prediction based on the user experience adjustment.

16. The one or more computer storage media of claim 15, further comprising determining the user experience adjustment to the user experience by applying a home coverage deduction to a churn rate for each of the subscribers, the home coverage deduction determined based on the proposed cell deployment location, a home coverage location for each of the subscribers, and predicted cell coverage data upon deploying the cell at the proposed cell deployment location.

17. The one or more computer storage media of claim 16, further comprising determining the home coverage deduction for each of the subscribers based on applying a geospatial analysis technique to extract a number of households per small cell footprint from census blocks data corresponding to deploying the cell at the proposed cell deployment location.

18. The one or more computer storage media of claim 17, further comprising determining the home coverage deduction for each of the subscribers by extrapolating echolocation data for a coverage area corresponding to deploying the cell at the proposed cell deployment location and comparing the echolocation data with the households per small cell footprint and the home coverage location for each of the subscribers.

19. The one or more computer storage media of claim 18, further comprising determining the user experience adjustment by applying a latency deduction to the churn rate, the latency deduction determined based on the proposed cell deployment location, the home coverage location for each of the subscribers, and the predicted cell coverage data upon deploying the cell at the proposed cell deployment location.

20. The one or more computer storage media of claim 19, further comprising determining the user experience adjustment by applying a leakage deduction to the churn rate.
